(19) United States
(12) Patent Application Publication
(10) Pub. No.: US 2008/0055668 A1
(43) Pub. Date: Mar. 6, 2008

(54) Image reading apparatus, image reading method, and program

(75) Inventor: Ryoichi Hirayama, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/897,359

(22) Filed: Aug. 30, 2007

(30) Foreign Application Priority Data
Aug. 31, 2006 (JP) 2006-236363

(51) Int. Cl. H04N 1/401

(52) U.S. Cl. 358/461

(57) ABSTRACT

An image reading apparatus includes an image reading sensor reading an image from a document, a light source turned on at a time when the image is read from the document by the image reading sensor, a data acquisition unit acquiring white reference data and black reference data which are used for performing shading correction for the image read by the image reading sensor, and a white reference plate for acquiring the white reference data, wherein the image reading sensor moves relative to the white reference plate while facing the white reference plate when the white reference data and the black reference data are acquired by the data acquisition unit, wherein the light source is repeatedly turned on and turned off when the image reading sensor moves relative to the white reference plate, and wherein the data acquisition unit acquires the white reference data on the basis of a detection signal that can be acquired from the image reading sensor at a time when the light source is turned on and acquires the black reference data on the basis of a detection signal that can be acquired from the image reading sensor at a time when the light source is turned off.

The entire disclosure of Japanese Patent Application No. 2006-236363, filed Aug. 31, 2006 is expressly incorporated by reference herein.

### BACKGROUND

1. Technical Field

The present invention relates to an image reading apparatus and an image reading method which acquire white reference data and black reference data used for performing a shading correction process for a read image.

2. Related Art

In image reading apparatuses such as scanners, generally, a shading correction process is performed for an image read from a document. Here, the shading correction process is performed for reduction of non-uniform sensitivity of a plurality of photoelectric conversion elements provided in a sensor for reading an image from a document which is provided in the image reading apparatus. In the shading correction process, a correction process is performed on the basis of white reference data and black reference data which are acquired prior to reading an image from a document in advance. While the white reference data is used as reference data for detecting a white color by using a photoelectric conversion element, the black reference data is used as reference data for detecting a black color by using a photoelectric conversion element. When a process of acquiring the white reference data is to be performed, it is necessary to read a reference white color by lighting a light source. Thus, generally, in an image reading apparatus, a component, which is commonly called a white reference plate, in the shape of a plate used for acquisition of the white reference data is disposed.

It is preferable that the acquisition process of the white and black reference data is performed each time an image is read from a document. However, when the white reference data and the black reference data are acquired each time an image is read from a document, a long time is required for reading the image.

Thus, a method of reducing the number of times acquisition is performed by omitting some of the acquisition processes, instead of acquiring the white and black reference data each time an image is read, has been proposed (see JP-A-11-355570).

However, since the white reference data and the black reference data are not acquired each time an image is read from a document by omitting some of the processes of acquiring the white and black reference data, there is a possibility that problems including deterioration of image quality of the read image and the like occur.

### SUMMARY

An advantage of some aspects of the invention is that it provides a method capable of reducing a time required for acquisition of the white and black reference data which are used for a shading correction process.

According to an aspect of the invention, there is provided an image reading apparatus including: an image reading sensor reading an image from a document; a light source turned on at a time when the image is read from the document by the image reading sensor; a data acquisition unit acquiring white reference data and black reference data which are used for performing shading correction for the image read by the image reading sensor; and a white reference plate for acquiring the white reference data. The image reading sensor moves relative to the white reference plate while facing the white reference plate when the white reference data and the black reference data are acquired by the data acquisition unit, and the light source is repeatedly turned on and turned off when the image reading sensor moves relative to the white reference plate. The data acquisition unit acquires the white reference data on the basis of a detection signal that can be acquired from the image reading sensor at a time when the light source is turned on and acquires the black reference data on the basis of a detection signal that can be acquired from the image reading sensor at a time when the light source is turned off.

Other features of the invention will become more apparent by describing exemplary embodiments thereof with reference to the attached drawings.

### BRIEF DESCRIPTION OF THE DRAWINGS

The invention will be described with reference to the accompanying drawings, wherein like numbers reference like elements.

FIG. 1 is a perspective view of a multifunctional apparatus according to an embodiment of the invention as an example.

FIG. 2 is a perspective view of a scanner unit of a multifunctional apparatus according to an embodiment of the invention in a case where a cover of the scanner unit is opened.

FIG. 3 is a perspective view of a printer unit of a multifunctional apparatus according to an embodiment of the invention.

FIG. 4 is a schematic diagram showing a structure of a scanner unit and a printer unit of a multifunctional apparatus according to an embodiment of the invention.

FIG. 5 is a diagram showing a system structure of a control unit of a multifunctional apparatus according to an embodiment of the invention, as an example.

FIG. 6 is a diagram showing a structure of a scanner control section 100 according to an embodiment of the invention as an example.

FIG. 7 is a diagram showing an image sensor according to an embodiment of the invention as an example.

FIG. 8A is a diagram showing an exposure lamp according to an embodiment of the invention, as an example.

FIG. 8B is a diagram showing an order of an exposure lamp according to an embodiment of the invention as an example.

FIG. 9 is a diagram showing a position of a scanner carriage according to an embodiment of the invention in a case where a shading process is performed.

FIG. 10 is a flowchart showing an execution flow of an ordinary shading process.

FIG. 11 is a flowchart showing an execution flow of a high-speed shading process according to an embodiment of the invention.

FIG. 12 is a diagram showing execution timings of the ordinary shading and the high-speed shading.

FIG. 13 is a flowchart showing a sequence of determination of an execution condition of the high-speed shading, as an example.

FIG. 14 is a flowchart showing a sequence of a light source warm-up process according to an embodiment of the invention as an example.

FIG. 15 is a flowchart showing a sequence of an AFE calibration process according to an embodiment of the invention as an example.

FIG. 16 is a flowchart showing a method of omitting the light source warm-up process and the AFE calibration process, as an example.

FIG. 17 is a flowchart showing a case where the method is applied in practical used.

FIG. 18 is a diagram showing execution timing for the processes.

### DESCRIPTION OF EXEMPLARY EMBODIMENTS

By descriptions in exemplary embodiments of the invention and attached drawings, at least features of the invention described below will become more apparent.

According to a first aspect of the invention, there is provided an image reading apparatus including: an image reading sensor reading an image from a document; a light source turned on at a time when the image is read from the document by the image reading sensor; a data acquisition unit acquiring white reference data and black reference data which are used for performing shading correction for the image read by the image reading sensor; and a white reference plate for acquiring the white reference data. The image reading sensor moves relative to the white reference plate while facing the white reference plate when the white reference data and the black reference data are acquired by the data acquisition unit, and the light source is repeatedly turned on and turned off when the image reading sensor moves relative to the white reference plate. The data acquisition unit acquires the white reference data on the basis of a detection signal that can be acquired from the image reading sensor at a time when the light source is turned on and acquires the black reference data on the basis of a detection signal that can be acquired from the image reading sensor at a time when the light source is turned off.

In the image reading apparatus, since, when the image reading sensor moves relative to the white reference plate while facing the white reference plate when the white reference data and the black reference data are acquired by the data acquisition unit, the light source is repeatedly turned on and turned off and the data acquisition unit acquires the white reference data on the basis of a detection signal that can be acquired from the image reading sensor at a time when the light source is turned on and acquires the black reference data on the basis of a detection signal that can be acquired from the image reading sensor at a time when the light source is turned off, it is possible to reduce a time required for acquisition of the white and black reference data.

The light source of the image reading apparatus may be repeatedly turned on and turned off at predetermined time intervals. In such a case, since the light source is repeatedly turned on and turned off at predetermined time intervals, it is possible to acquire appropriate white and black reference data.

The image reading sensor of the image reading apparatus may move relative to the white reference plate at a predetermined moving speed. In such a case, since the image reading sensor moves relative to the white reference plate at a predetermined moving speed, it is possible to acquire appropriate white and black reference data.

In the image reading apparatus, the white reference data and the black reference data may be acquired by the data acquisition unit before the image is read from the document by the image reading sensor. In such a case, since the white reference data and the black reference data are acquired by the data acquisition unit before the image is read from the document by the image reading sensor, it is possible to acquire appropriate white and black reference data.

In the image reading apparatus, an operation in which the image reading sensor moves relative to the white reference plate while facing the white reference plate and the light source is repeatedly turned on and turned off may be performed when an image reading condition corresponds to a predetermined condition. In such a case, since the operation in which the image reading sensor moves relative to the white reference plate while facing the white reference plate and the light source is repeatedly turned on and turned off is performed when an image reading condition corresponds to a predetermined condition, it is possible to acquire appropriate white and black reference data.

In the image reading apparatus, other operation other than the above-described operation may be performed when the image reading condition does not correspond to the predetermined condition. In such a case, since the other operation other than the above-described operation is performed when the image reading condition does not correspond to the predetermined condition, it is possible to acquire appropriate white and black reference data when the image reading condition does not correspond to the predetermined condition.

In the image reading apparatus, as the other operation, the light source may be turned off and the data acquisition unit may acquire the black reference data on the basis of the detection signal that can be acquired from the image reading sensor by the data acquisition unit before the image reading sensor moves relative to the white reference plate, and the light source may be turned on and the data acquisition unit may acquire the white reference data on the basis of the detection signal that can be acquired from the image reading sensor by the data acquisition unit when the image reading sensor moves relative to the white reference plate, facing the white reference plate. In such a case, since, as the other operation, the light source is turned off and the data acquisition unit acquires the black reference data on the basis of the detection signal that can be acquired from the image reading sensor by the data acquisition unit before the image reading sensor moves relative to the white reference plate and the light source is turned on and the data acquisition unit acquires the white reference data on the basis of the detection signal that can be acquired from the image reading sensor by the data acquisition unit when the image reading sensor moves relative to the white reference plate, facing the white reference plate, it is possible to acquire appropriate white and black reference data when the image reading condition does not correspond to the predetermined condition.

In the image reading apparatus, the data acquisition unit may acquire the white reference data or the black reference data on the basis of the detection signal for a plurality of lines which can be acquired from the image reading sensor. In such a case, since the data acquisition unit acquires the white reference data or the black reference data on the basis of the detection signal for a plurality of lines which can be acquired from the image reading sensor, it is possible to acquire further appropriate white and black reference data.

In the image reading apparatus, a setting process for setting values in a signal amplifier circuit amplifying a signal output from the image reading sensor and a light intensity control unit controlling light intensity of the light source may be performed before the white reference data and the black reference data are acquired by the data acquisition unit. In such a case, since the setting process is performed before the white and black reference data are acquired by the data acquisition unit, it is possible to acquire further appropriate white and black reference data.

In the image reading apparatus, the setting process may be performed on the basis of the signal that is output from the image reading sensor having detected the light intensity of the light source and is amplified by the signal amplifier circuit. In such a case, since the setting process is performed on the basis of the signal that is output from the image reading sensor having detected the light intensity of the light source and is amplified by the signal amplifier circuit, the setting process can be performed in a simple manner.

In the image reading apparatus, when the image reading condition corresponds to the predetermined condition, the light intensity of the light source that is controlled to be turned on by the light intensity control unit in which the setting values are set by the setting process may be detected by the image reading sensor and it may be determined whether the light intensity of the light source is in a predetermined range on the basis of the signal that is output from the image reading sensor having detected the light intensity of the light source and is amplified by the signal amplifier circuit in which the values are set, when it is determined that the light intensity of the light source is not in the predetermined range, the setting process may be performed, and when it is determined that the light intensity of the light source is in the predetermined range, the setting process may not be performed. In such a case, since when the image reading condition corresponds to the predetermined condition, the light intensity of the light source that is controlled to be turned on by the light intensity control unit in which the setting values are set by the setting process is detected by the image reading sensor and it is determined whether the light intensity of the light source is in a predetermined range on the basis of the signal that is output from the image reading sensor having detected the light intensity of the light source and is amplified by the signal amplifier circuit in which the values are set, when it is determined that the light intensity of the light source is not in the predetermined range, the setting process is performed, and when it is determined that the light intensity of the light source is in the predetermined range, the setting process is not performed, it is possible to reduce a time required for performing the process.

According to a second aspect of the invention, there is provided an image reading method including: moving an image reading sensor relative to a white reference plate while the image reading sensor faces the white reference plate when white reference data and black reference data which are used for performing shading correction for an image read by the image reading sensor are to be acquired before the image is read from a document by the image reading sensor; repeating operations for alternately turning on and turning off a light source to be turned on at a time when the image reading sensor moves relative to the white reference plate; and acquiring the white reference data on the basis of a detection signal that can be acquired from the image reading sensor at a time when the light source is turned on and acquiring the black reference data on the basis of a detection signal that can be acquired from the image reading sensor at a time when the light source is turned off.

According to a third aspect of the invention, there is provided a program executable in an image reading apparatus, the program executing a method including: moving an image reading sensor relative to a white reference plate while the image reading sensor faces the white reference plate when white reference data and black reference data which are used for performing shading correction for an image read by the image reading sensor are to be acquired before the image is read from a document by the image reading sensor; repeating operations for alternately turning on and turning off a light source to be turned on at a time when the image reading sensor moves relative to the white reference plate; acquiring the white reference data on the basis of a detection signal that can be acquired from the image reading sensor at a time when the light source is turned on; and acquiring the black reference data on the basis of a detection signal that can be acquired from the image reading sensor at a time when the light source is turned off.

### Overview of Image Reading Apparatus

Hereinafter, an image reading apparatus according to an embodiment of the invention will be described. Here, a multifunctional apparatus having a scanner unit that generates image data by reading an image from a document and a printer unit that prints on a medium will be described, as an example of the image reading apparatus.

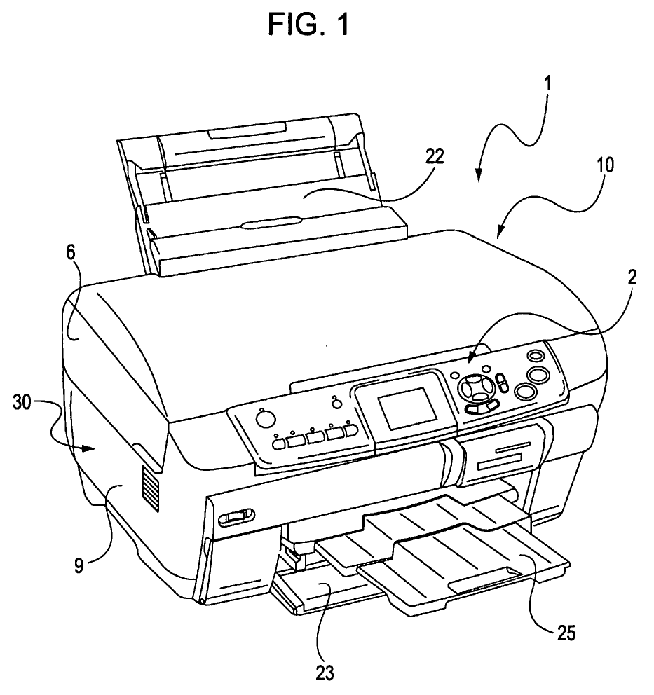

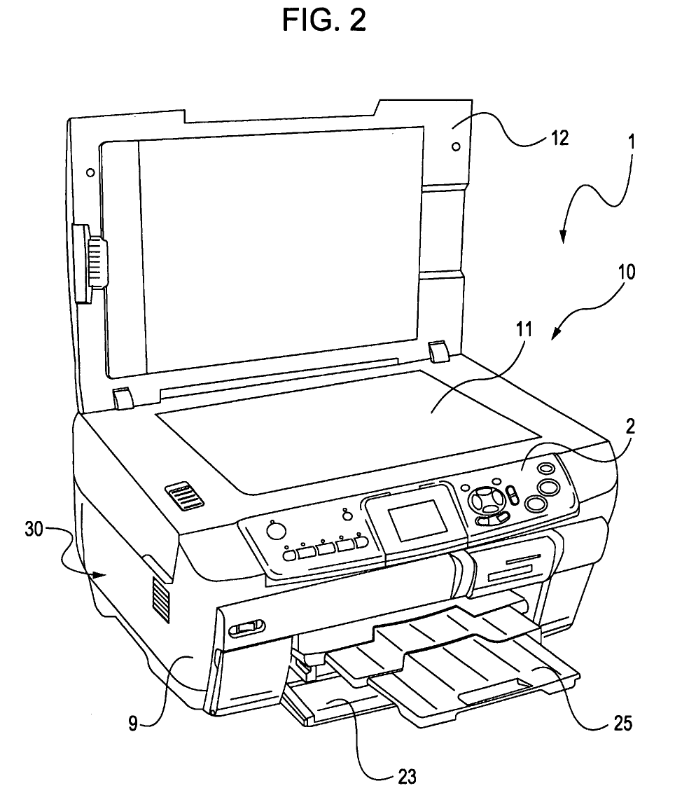

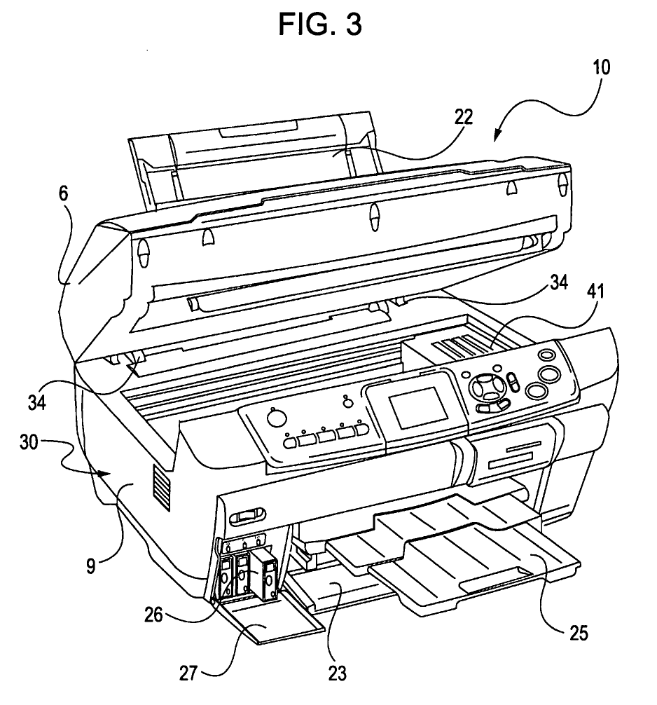

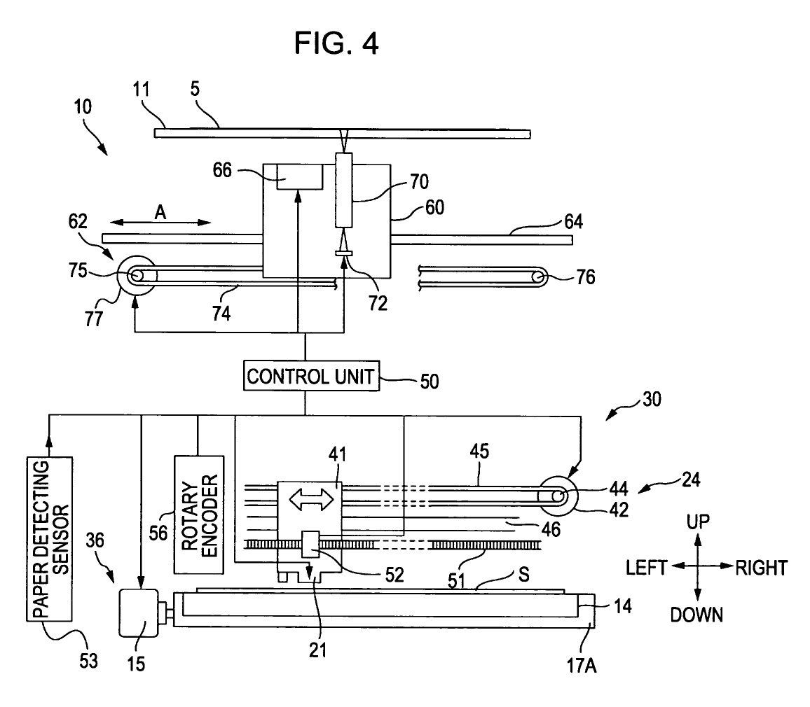

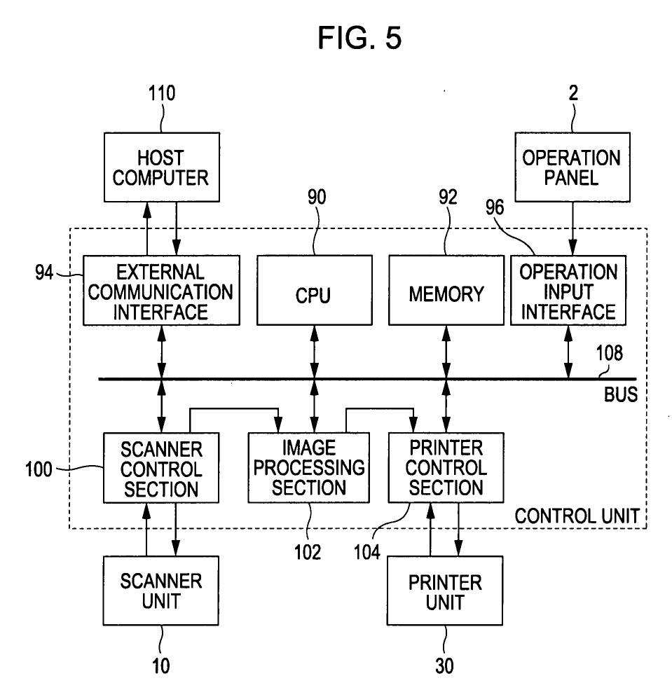

FIGS. 1 to 5 are for describing an example of the multifunctional apparatus 1. FIG. 1 is a perspective view of the multifunctional apparatus 1 showing its external appearance. FIG. 2 is a perspective view of a scanner unit 10 of the multifunctional apparatus 1. FIG. 3 is a perspective view of a printer unit of the multifunctional apparatus 1. FIG. 4 is a schematic diagram showing an internal structure of the multifunctional apparatus 1. FIG. 5 is a diagram showing a system structure of the multifunctional apparatus 1, as an example.

The multifunctional apparatus 1 has a scanner function for reading an image from a document and generating image data, a print function for printing on various media such as printing paper on the basis of print data sent from a host computer (not shown), and a local copy function for copying the image read from the document by printing it on a medium. The multifunctional apparatus 1, as shown in FIG. 1, has the scanner unit 10 for reading an image from a document 5 in its upper portion. In addition, the multifunctional apparatus 1, has a printer unit 30 for printing on a medium S such as printing paper in its lower portion. In a front portion of the multifunctional apparatus 1, an operation panel 2 is provided.

The scanner unit 10, as shown in FIG. 2, has a document plate 11 in which a glass plate for setting a document is provided and a document plate cover 12 that covers the document plate 11 from an upper side. The document plate cover 12 is attached to a rear end of the multifunctional apparatus 1 to be pivotable and serves to reveal or cover an upper side of the document plate 11.

The printer unit 30, as shown in FIG. 3, is configured to open its internal portion externally by lifting the scanner unit 10 upward. In other words, the scanner unit 10 is installed in a rear portion of the multifunctional apparatus 1 through a hinge portion 34 so as to be freely pivotable. When the scanner unit 10 is lifted upward, the internal portion of the printer unit 30 is revealed. Inside the printer unit 30, a carriage 41 and the like are disposed. In the carriage 41, a printer head (not shown) for ejecting ink is provided. While moving with the carriage 41, the print head performs a printing operation by ejecting ink toward a medium such as printing paper.

In addition, a transport unit (not shown) for transporting the medium is provided in the printer unit 30. The transport unit transports the medium set in a rear supply port 22 provided on a rear side of the multifunctional apparatus 1 or in a front supply port 23 provided on a front side of the multifunctional apparatus 1 to the internal portion of the printer unit 30 and discharges the medium printed by the print head through a discharge tray 25 provided on the front side of the multifunctional apparatus 1.

On a left or right side of a front side of a lower portion 9 of the multifunctional apparatus 1, an ink cartridge cover 27 is provided. When an ink cartridge 26 is to be installed or replaced, a user opens the ink cartridge cover 27 and installs or replaces the ink cartridge 26. By the user's closing of the ink cartridge cover 27 after installing or replacing the ink cartridge 26, an operation for setting the ink cartridge 26 is completed. In the ink cartridge 26, ink is housed, and the ink is supplied to the printer head that is built into the carriage 41.

### Internal Mechanisms of Scanner Unit and Printer Unit

FIG. 4 is a diagram showing internal mechanisms of the scanner unit 10 and the printer unit 30.

### Scanner Unit

The scanner unit 10, as shown in an upper portion of the figure, has a scanner carriage 60 that is disposed below the document plate 11, a driving mechanism 62 that moves the scanner carriage 60 in a direction denoted by arrow A while being spaced apart from the document plate 11 by a predetermined distance, and a guide 64 that supports the scanner carriage 60 so as to guide its movement.

The scanner carriage 60 has an exposure lamp 66 that is used as a light source emitting light on the document 5 through the document plate 11, and a lens 70 on which light reflected by the document 5 is incident, and an image sensor 72 that receives reflected light entering inside the scanner carriage 60 through the lens 70. Here, the exposure lamp 66 corresponds to a light source, and the image sensor 72 corresponds to an image reading sensor.

In this embodiment, the image sensor 72 is constituted by a CIS sensor in which photoelectric conversion elements such as photodiodes used for converting optical signals into electrical signals are arranged in an array. The image data read by the image sensor 72 is output to a control unit 50.

The driving mechanism 62 has a timing belt 74 that is connected to the scanner carriage 60, a pair of pulleys 75 and 76 over which the timing belt 74 is engaged, and a driving motor 77 that drives one pulley 75 to be rotated. The driving motor 77 is controlled by a control signal transmitted from the control unit 50.

### Printer Unit

The printer unit 30, as shown in a lower portion of FIG. 4, has a printer carriage 41, a printer head 21 built in the printer carriage 41, a driving mechanism 24 moving the printer carriage 41 relative to and parallel to a medium S while being spaced apart from the medium S by a predetermined distance, and a transport mechanism 36 transporting the medium S in a direction perpendicular to a moving direction of the printer carriage 41.

The printer head 21 ejects ink of each color supplied from the ink cartridge 26, described above with reference to FIG. 3, toward the medium S so as to form dots on the medium S, and thereby an image is printed on the medium S.

The driving mechanism 24 has a timing belt 45 connected to the printer carriage 41, a pulley 44 engaged with the timing belt 45, a carriage motor 42 driving the pulley 44 to be rotated, a guide rail 46 guiding movement of the printer carriage 41, a linear encoder code plate 51 as a linear encoder detecting a location of the printer carriage 41, and a detection unit 52 reading the linear encoder code plate 51. The driving mechanism 24 drives the carriage motor 42 so as to rotate the timing belt 45 through the pulley 44. Accordingly, the printer carriage 41 moves relative to the medium S along the guide rail 46. The carriage motor 42 is controlled to be driven on the basis of a control signal transmitted from the control unit 50.

The transport mechanism 36 has a platen 14, a transport roller 17A, a transport motor 15 driving the transport roller 17A to be rotated, a paper detecting sensor 53 detecting whether the medium S has reached a predetermined location, and a rotary encoder 56 detecting a rotation amount of the transport roller 17A. The platen 14 is disposed to face the printer head 21. When the transport motor 15 is driven, the transport roller 17A rotates, and thereby the medium S is transported over the platen 14. The transport motor 15 is controlled to be driven on the basis of a control signal transmitted from the control unit 50.

When a printing operation is performed, the medium S is intermittently transported by the transport roller 17A by a predetermined transport amount, and between the intermittent transporting operations, the printer carriage 41 is moved in a direction perpendicular to the transport direction by the transport roller 17A, and ink is ejected from the printer head 21 toward the medium S, thereby a printing operation is performed.

### Control Unit

### Structure of Control Unit

FIG. 5 is a diagram showing a structure of the control unit 50 of the multifunctional apparatus 1, as an example. The control unit 50, as shown in the figure, has a CPU 90, a memory 92, an external communication interface 94, an operation input interface 96, a scanner control section 100, an image processing section 102, and a printer control section 104. The CPU 90, the memory 92, the external communication interface 94, the operation input interface 96, the scanner control section 100, the image processing section 102 and the printer control section 104 are connected to each other through a bus 108.

The CPU 90 is responsible for the overall control operations of the multifunctional apparatus 1. In other words, the CPU 90 controls the external communication interface 94, the operation input interface 96, the scanner control section 100, the image processing section 102 and the printer control section 104. In the memory 92, a program executed by the CPU 90, data used in the program, or the like is stored. The memory 92 is constituted by a non-volatile memory such as a ROM, a RAM, or a flash memory.

The external communication interface 94 communicates with a host computer 110 that is connected to the multifunctional apparatus 1 by using a wire or wireless communication method. In particular, the external communication interface 94 receives various data such as print data or a command and sends data for an image read from a document by the scanner unit 10 to the host computer 110.

The operation input interface 96 receives an operation input from a user through various operation buttons provided on the operation panel 2. In addition, the operation input interface 96 transfers the operation input, which has been input from the user through the various operation buttons, to the CPU 90.

The scanner control section 100 controls the scanner unit 10. In particular, the scanner control section 100 controls a driving motor 77 of the driving mechanism 62 that moves the scanner carriage 60 of the scanner unit 10 or controls the exposure lamp 66, the image sensor, and the like which are provided in the scanner carriage 60. Accordingly, the scanner control section 100 drives the driving motor 77 of the driving mechanism 62 so as to move the scanner carriage 60 relative to the document 5 and performs a reading operation for reading an image from the document 5 through the image sensor 72 of the scanner carriage 60. The scanner control section 100 will be described later in detail.

The image processing section 102 serves to convert image data output from the scanner unit 10 into data for a printing process performed by the printer unit 30 when the image read from the document 5 by the scanner unit 10 is to be printed on a medium by the printer unit 30. In particular, the image processing section 102 converts RGB data received from the scanner control section 100 as data of the image read from the document 5 by the scanner unit 10 into CMYK data. Here, while the RGB data is image data represented by three color spaces of red (R), green (G) and blue (B), the CMYK data is image data represented by four color spaces of cyan (C), magenta (M), yellow (Y), and black (K). The image processing section 102 converts the CMYK data acquired by this conversion process into binary data (or 2 bit data) by performing a half tone process for the CMYK data. The binary data (or 2 bit data) is used for a printing process performed by the printer unit 30. The binary data (or 2 bit data) generated as such is output to the printer control section 104.

The printer control section 104 controls the printer unit 30. In particular, the printer control section 104 controls a carriage motor 42 of the driving mechanism 24 that moves the printer carriage 41 of the printer unit 30, a transport motor 15 of the transport mechanism 36 that transports a medium, and an ink ejecting process from the printer head 21. Accordingly, the printer control section 104 controls the printer head 21 so as to eject ink toward the medium for printing on the medium while driving the carriage motor 42 of the driving mechanism 24 and the transport motor 15 of the transport mechanism 36.

### Operation of Control Unit

### (1) Scanner Mode

A scanner mode is started, for example, in accordance with an image reading command sent from the host computer 110 which is received by the external communication interface 94. In this scanner mode, the CPU 90 controls the scanner control section 100 on the basis of reading information such as reading resolution and a reading area sent from the host computer 110 which is received through the external communication interface 94 for a reading operation performed by the scanner unit 10. Here, the scanner control section 100 moves the scanner carriage 60 relative to the document 5 by driving the driving motor 77 of the driving mechanism 62 that moves the scanner carriage 60 of the scanner unit 10 in accordance with a command sent from the CPU 90. Accordingly, the scanner control section 100 reads an image from the document 5 through the image sensor 72 provided in the scanner carriage 60. The scanner control section 100 receives data of the read image from the scanner unit 10. Then, the scanner control section 100 sends the data of the image acquired from the scanner unit 10 to the host computer 110 through the external communication interface 94.

### (2) Printer Mode

A printer mode is started, for example, in accordance with a print command sent from the host computer 110 which is received by the external communication interface 94. In this printer mode, the CPU 90 controls the printer control section 104 on the basis of print data sent from the host computer 110, which is received through the external communication interface 94, for performing a printing operation. Here, the printer control section 104, in accordance with a command sent from the CPU 90, controls the carriage motor 42 of the driving mechanism 24 that moves the printer carriage 41 of the printer unit 30, the transport motor 15 of the transport mechanism 36 that transports a medium, and an ink ejecting process from the printer head 21. Accordingly, the printer control section 104 performs a printing operation by ejecting ink from the printer head 21 provided in the printer carriage 41 toward the medium.

### (3) Copy Mode

A copy mode is started, for example, by a setting operation using a mode selecting button 85. In this copy mode, when a predetermined button or the like disposed on the operation panel 2 is operated by a user, the operation is sent to the CPU 90 through the operation input interface 96. The CPU 90 sends a command for an operation for reading an image from the document to be performed by the scanner unit 10 to the scanner control section 100. The scanner control section 100 drives the driving motor 77 of the driving mechanism 62 that moves the scanner carriage 60 of the scanner unit 10 in accordance with this command, and thereby moves the scanner carriage 60 relative to the document 5. Accordingly, the scanner control section 100 controls the image sensor 72 provided in the scanner carriage 60 to perform a reading operation for reading an image from the document 5. The scanner control section 100 receives the image data read by the image sensor 72 from the scanner unit 10. Then, the scanner control section 100 outputs the image data acquired from the scanner section 10 to the image processing section 102.

The image processing section 102 converts image data output from the scanner control section 100 into data for a printing process performed by the printer unit 30. Here, the image processing section 102 converts the image data output as RGB data from the scanner control section 100 into CMYK data. The image processing section 102 converts the CMYK data acquired by this conversion process into binary data (or 2 bit data) by performing a half tone process for the CMYK data. The binary data (or 2 bit data) is used for a printing process performed by the printer unit 30. The image processing section 102 outputs the generated binary data (or 2 bit data) to the printer control section 104.

The printer control section 104 ejects ink from the printer head 21 on the basis of the binary data (or 2 bit data) output from the image processing section 102 in accordance with a command sent from the CPU 90. At this moment, the printer control section 104 controls the carriage motor 42 of the driving mechanism 24 that moves the printer carriage 41 of the printer unit 30 and the transport motor 15 of the transport mechanism 36 that transports a medium. Accordingly, the printer control section 104 performs a printing process on the medium.

### Scanner Control Section

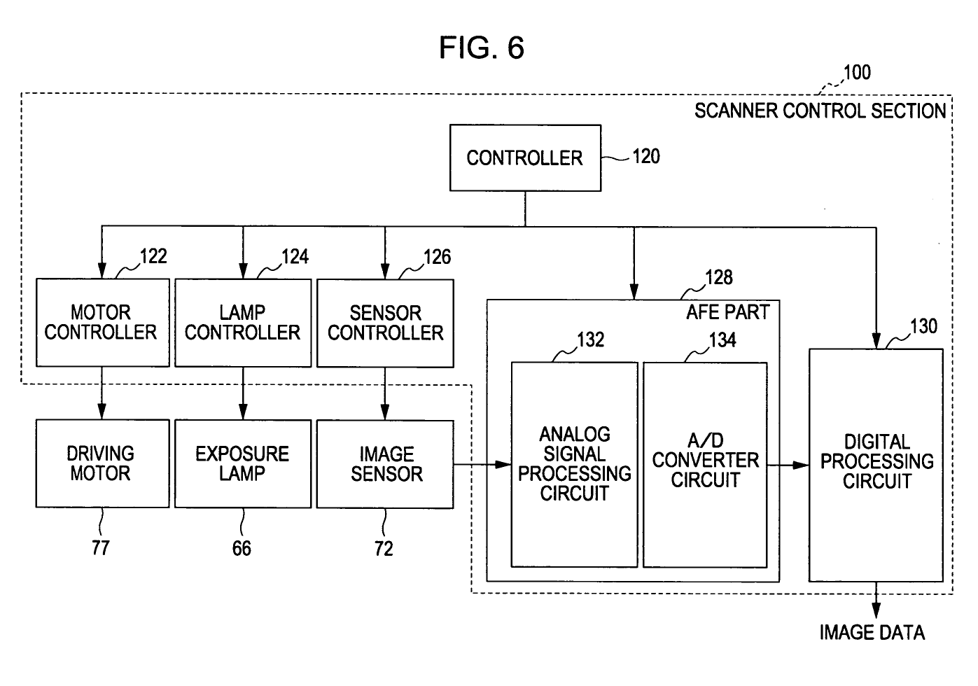

FIG. 6 is a diagram showing a structure of the scanner control section 100 as an example. The scanner control section 100, as shown in the figure, has a controller 120, a motor controller 122, a lamp controller 124, a sensor controller 126, an AFE (Analog Front End) part 128, and a digital processing circuit 130. The AFE (Analog Front End) part 128 has an analog signal processing circuit 132 and an A/D converter circuit 134. Here, the lamp controller 124 corresponds to a light intensity control unit, and the AFE (Analog Front End) part 128 corresponds to a signal amplifier circuit.

The controller 120 controls the motor controller 122, the lamp controller 124, the sensor controller 126, the AFE (Analog Front End) part 128, and the digital processing circuit 130 on the basis of a command sent from the CPU 90 or the like. The motor controller 122 controls driving of the driving motor 77 for moving the scanner carriage 60 in accordance with a command sent from the controller 120. The lamp controller 124 controls light emission of the exposure lamp 66. The sensor controller 126 controls the image sensor 72.

The analog signal processing circuit 132 of the AFE (Analog Front End) part 128 performs signal processing for an analog signal of the image read by the image sensor 72. The A/D converter circuit 134 of the AFE (Analog Front End) part 128 converts the image signal processed by the analog signal processing circuit 132 into a digital signal as an A/D converting process.

The digital processing circuit 130 performs digital signal processing for the digital signal sent from the A/D converter circuit 134 of the AFE (Analog Front End) part 128. Here, a correction process such as a shading correction process is started, and various image processing operations are performed.

The digital signal for which the digital processing has been performed is output as the data of the image (image data) read from the document 5 through the external communication interface 94 externally, here, that is, the host computer 110 connected to the multifunctional apparatus 1, or is sent to the image processing section 102 for printing the read image on a medium.

### Image Sensor

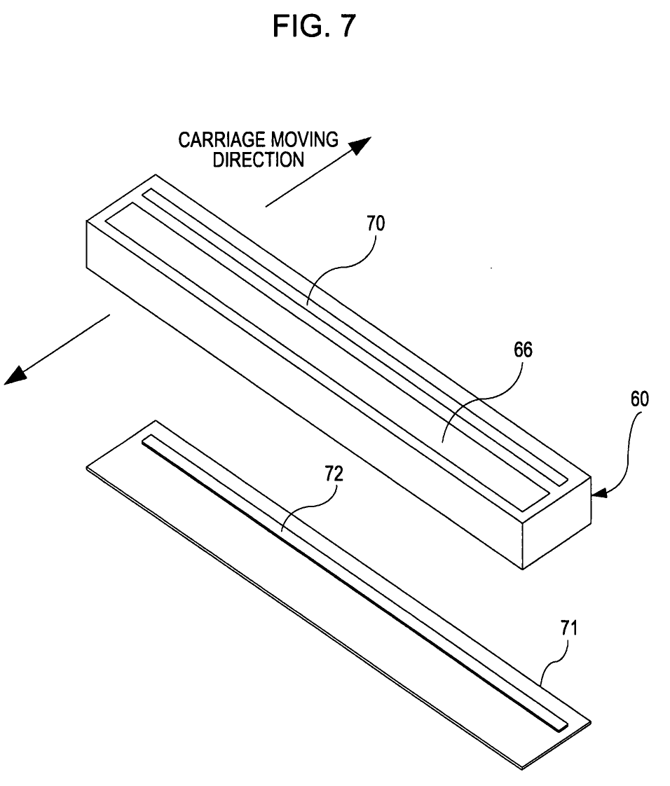

FIG. 7 is a diagram showing an image sensor 72 as an example. In this embodiment, the image sensor 72 is installed inside the scanner carriage 60. The scanner carriage 60, as shown in the figure, is formed to be long in a direction perpendicular to a moving direction of the scanner carriage 60 (carriage's moving direction). The scanner carriage 60 is sled in the carriage's moving direction so as to move parallel when an image is to be read. In an upper portion of the scanner carriage 60, a lens 70 used for making light incident on the image sensor 72 is provided while facing the document plate 11. On the lens 70, light reflected from the document is incident. The lens 70 is disposed in a length direction of the scanner carriage 60, that is, a direction perpendicular to the carriage's moving direction. In the upper portion of the scanner carriage 60, an exposure lamp 66 emitting light onto the document 5 through the document plate 11 is disposed to be parallel to the lens 70.

Inside the scanner carriage 60, as shown in the figure, a substrate 71 in which an image sensor 72 is provided is disposed. The image sensor 72, as shown in the figure, is disposed corresponding to the lens 70 in the length direction of the scanner carriage 60, that is, a direction perpendicular to the carriage's moving direction, like the lens 70. On a top face of the image sensor 72, a plurality of photoelectric conversion elements such as photodiodes are disposed in the length direction of the scanner carriage 60.

### Exposure Lamp

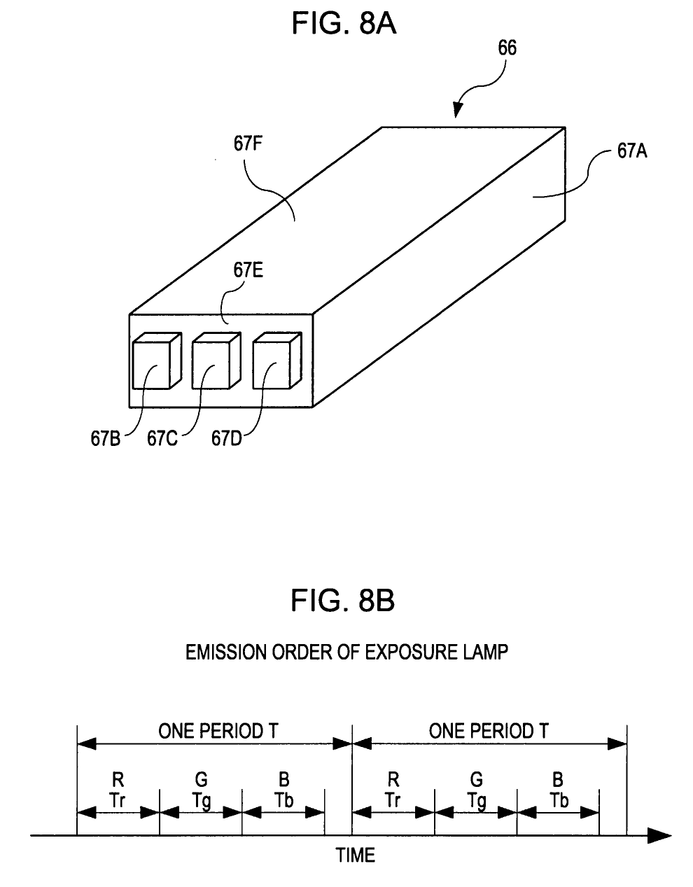

FIG. 8A is a diagram showing an exposure lamp 66 as an example. The exposure lamp 66, as shown in the figure, has a light guiding body 67A and three types of LED lamps 67B, 67C, and 67D having emission colors different from each other. The three types of LED lamps are, namely, a red (R) LED lamp 67B, a green (G) LED lamp 67C, and a blue (B) LED lamp 67D and are provided in an end portion 67E of the light guiding body 67A.

The light guiding body 67A, as shown in the figure, is disposed in a length direction of the lens 70. This light guiding body 67A introduces light emitted from the LED lamps 67B, 67C, and 67D of R, G, and B colors, respectively, provided in its end portion 67E inside the light guiding body 67A and emits the light from an exposure side 67F provided in its upper portion. The color emitted by the light guiding body 67A varies depending on the color of the LED lamp 67B, 67C, or 67D that is turned on. In other words, when the LED lamp 67B of red (R) is turned on, the light guiding body 67A emits light of a red (R) color. In addition, when the LED lamp 67C of green (G) is turned on, the light guiding body 67A emits light of a green (G) color, and when the LED lamp 67D of blue (B) is turned on, the light guiding body 67A emits light of a blue (B) color.

When an image is read from the document 5 by the image sensor 72, the LED lamps 67B, 67C, and 67D of R, G, and B colors, respectively, are sequentially turned on at different timings. In other words, for example, the LED lamps 67B, 67C, and 67D of R, G, and B colors, respectively, are sequentially turned on in the order of red (R)->green (G)->blue (B).

FIG. 8B is a diagram showing an order of the LED lamps 67B, 67C, and 67D for light emission as an example. In the exposure lamp 66, the LED lamps 67B, 67C, and 67D of R, G, and B colors, respectively, as shown in the figure, are turned on one after another at different timings for one period T. The LED lamps 67B, 67C, and 67D of R, G, and B colors are, respectively, turned on only for a predetermined time Tr, Tg, and Tb for one period T which is set in advance. Accordingly, the intensities of light of the LED lamps 67B, 67C, and 67D of R, G, and B colors are controlled.

### Problem in Known Method and Solution Thereof

### Problem in Known Method

In the scanner control section 100 of the multifunctional apparatus 1, as described above, a shading correction process for the image read from the document is performed by the digital processing circuit 130, as described above. Here, the shading correction process is a correction process performed on the basis of white reference data and black reference data which are acquired in advance. While the white reference data is reference data used for detecting a white color by using the image sensor 72, the black reference data is reference data used for detecting a black color by using the image sensor 72.

Accordingly, the scanner control section 100 of the multifunctional apparatus 1 acquires the white reference data and the black reference data when reading an image from a document. However, when a known method for acquisition of the white and black reference data is used, a long time is required for this process. Thus, an additional time is required for reading the image from the document, whereby the processing efficiency thereof is deteriorated.

### Solution

Thus, according to an embodiment of the invention, a new acquisition method capable of reducing the time required for a process of acquiring the white and black reference data which is performed at a time when an image is read from a document is proposed. Hereinafter, a newly proposed acquisition process requiring a relatively short time will be referred to as “high speed-shading”, and a known acquisition process will be referred to as “ordinary shading”. First, the “ordinary shading” that has been performed will now be described in detail.

### Ordinary Shading

The “ordinary shading” is performed when the scanner carriage 60 is located in a predetermined position. Likewise, the “high speed-shading” is performed when the scanner carriage 60 is located in the predetermined position.

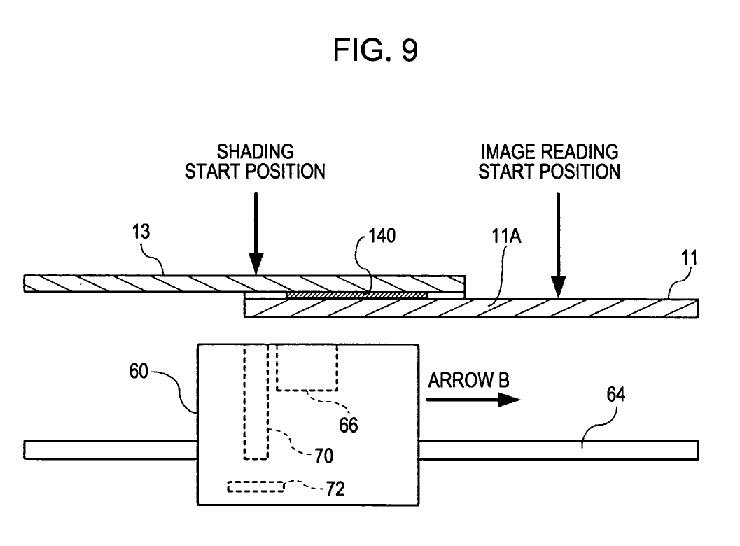

FIG. 9 is a diagram showing an appearance of the scanner carriage 60 at a time when the scanner carriage 60 is located in a predetermined position. Here, as the predetermined position in which the “ordinary shading” is performed, as shown in the figure, an appropriate position such as a home position side of the scanner carriage 60 is set. In other words, a dark position in which external light cannot reach and appropriate black reference data can be acquired, in particular, for example, a position slightly deviated from a place right below the document plate 11 is set as the predetermined position.

When the ordinary shading is performed, the scanner carriage 60 moves to a predetermined shading start position. Then, when the “ordinary shading” is started, the scanner carriage 60 acquires the black reference data while being stopped at the shading start position. At this moment, the exposure lamp 66 is in a status that the exposure lamp is turned off. The acquisition of the black reference data is performed by the image sensor 72. A detection signal output from the image sensor 72 is acquired by the controller 120 and the like of the scanner control section 100 through the AFE (Analog Front End) part 128 and the like. Here, the controller 120 and the like of the scanner control section 100 correspond to the data acquisition unit. The controller 120 and the like of the scanner control section 100 acquire the black reference data on the basis of the detection signal acquired from the image sensor 72. In particular, for example, the controller 120 and the like of the scanner control section 100 calculate average values of data for each 8 lines which is acquired from the image sensor 72 and acquire a maximum value among four average values as the black reference data.

As described above, after the controller 120 and the like of the scanner control section 100 complete acquisition of the black reference data, the scanner carriage 60 starts moving at a predetermined speed from the shading start position in a direction denoted by arrow B. At this moment, the scanner carriage 60 moves relative to the white reference plate 140. Here, the white reference plate 140 is a component in the shape of a plate installed for acquiring the white reference data. In this embodiment, the white reference plate 140, as shown in the figure, is installed in an outer frame of the document plate 11 to be inserted between a glass plate 11A of the document plate 11 and a cover 13 of the scanner unit 10.

The scanner carriage 60 passes right below the white reference plate 140 while facing the white reference plate 140. At this moment, the exposure lamp 66 is turned on. The exposure lamp 66 alternately lights the LED lamps 67B, 67C, and 67D of R, G, and B colors at different timings. The light output from the exposure lamp 66 is emitted on the white reference plate 140. The light output from the exposure lamp 66 is reflected by the white reference plate 140, and the reflected light is detected by the image sensor 72.

A detection signal output from the image sensor 72 is acquired by the controller 120 and the like of the scanner control section 100 through the AFE (Analog Front End) part 128 and the like. The controller 120 and the like of the scanner control section 100 acquire the white reference data on the basis of the detection signal sent from the image sensor 72. In particular, for example, the controller 120 and the like of the scanner control section 100 calculate average values of data for each 8 lines which is acquired from the image sensor 72 and acquires a maximum value among the four average values as the white reference data, when the scanner carriage 60 moves relative to the white reference plate 140.

Thereafter, the scanner carriage 60 continues to move in the direction denoted by arrow B at the predetermined moving speed, moves to the predetermined image reading start position, and continues to stop in the image reading start position until the timing for reading an image comes.

### Execution Flow

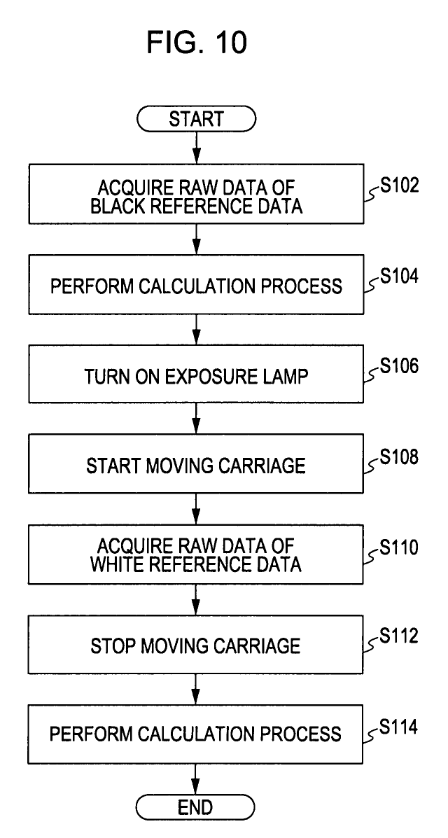

FIG. 10 is a flowchart showing an execution flow of the ordinary shading. First, raw data of the black reference data is acquired through the image sensor 72 in a status that exposure lamp 66 is turned off and the scanner carriage 60 stops (S102). At this moment, data for 8 lines is acquired four times as raw data of the black reference data. After the raw data of the black reference data is acquired as described above, the black reference data is acquired by calculation processes performed on the basis of the acquired raw data of the black reference data by the controller 120 and the like of the scanner control section 100 (S104).

After an operation for the acquisition of the black reference data is completed, the exposure lamp 66 is turned on (S106). Then, the scanner carriage 60 starts moving (S108). While the scanner carriage 60 moves, raw data of the white reference data is acquired through the image sensor 72 (S110). Here, for example, data for 8 lines is acquired four times as the raw data of the white reference data. After the raw data of the white reference data is acquired, the scanner carriage 60 stops (S112). Then, the white reference data is acquired by the calculation processes performed on the basis of the acquired raw data of the white reference data by the controller 120 and the like of the scanner control section 100 (S114). Then, the process ends promptly.

### High-Speed Shading

Unlike the ordinary shading in which the black reference data is acquired at a time when the scanner carriage 60 stops, in the high-speed shading, the black reference data is acquired when the scanner carriage 60 moves relative to the white reference plate 140. In other words, the black reference data is acquired together with the white reference data when the scanner carriage 60 moves while facing the white reference plate 140 so as to acquire the white reference data. Thus, the exposure lamp 66 is repeatedly turned on and turned off at predetermined time intervals while the scanner carriage 60 moves.

In other words, when the high-speed shading is started, the scanner carriage 60 starts moving from the predetermined shading start position instantly. Then, when the movement of the scanner carriage 60 is started, the exposure lamp 66 is repeatedly turned on and turned off. Accordingly, when the exposure lamp 66 is turned on, it is possible to acquire the raw data of the white reference data on the basis of the detection signal output from the image sensor 72. In addition, when the exposure lamp 66 is turned off, it is possible to acquire the raw data of the black reference data on the basis of the detection signal output from the image sensor 72.

In this embodiment, each time the exposure lamp 66 is turned on, the raw data of white reference data for four lines is acquired. In addition, each time the exposure lamp 66 is turned off, the raw data of black reference data for four lines is acquired. The exposure lamp 66 is turned on four times from a time when the scanner carriage 60 starts moving for performing the high-speed shading to a time when the moving of the scanner carriage 60 is completed. Accordingly, the raw data of four times X four lines is acquired as the raw data of the white reference data. In addition, the raw data of four times X four lines is acquired as the raw data of the black reference data.

Each time the raw data of the white reference data for four lines is acquired through the image sensor 72, the controller 120 and the like of the scanner control section 100 calculate an average value of the raw data of the white reference data, and acquire a maximum value among the four average values as the white reference data. In addition, each time the raw data of the black reference data for four lines is acquired through the image sensor 72, the controller 120 and the like of the scanner control section 100 calculate an average value of the raw data of the black reference data and acquire a maximum value among the four average values as the black reference data.

When the acquisition of the raw data of the white reference data and the raw data of the black reference data is completed by the controller 120 and the like of the scanner control section 100, the scanner carriage 60 continues to move at the predetermined speed in the direction denoted by arrow B, moves to the predetermined image reading start position, and stops in the image reading start portion and waits until the timing for reading an image comes.

### Execution Flow

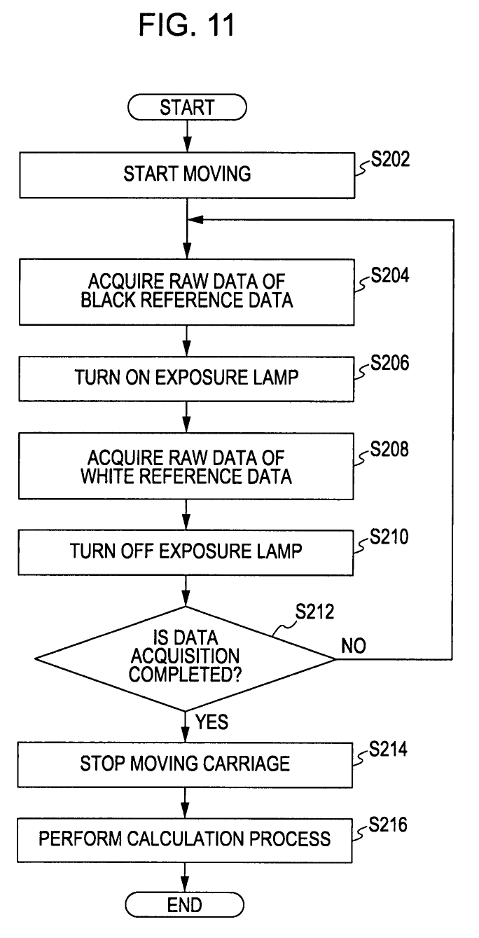

FIG. 11 is a flowchart showing an execution flow of the high-speed shading. First, the scanner carriage 60 starts moving relative to the white reference plate 140 while facing the white reference plate 140 (S202). At this moment, the exposure lamp 66 is in a status that the exposure lamp is turned off. Then, the raw data of the black reference data is acquired through the image sensor 72 (S204). At this moment, for example, data for four lines is acquired as the raw data of the black reference data.

After the raw data of the black reference data for four lines is acquired as described above, the exposure lamp 66 is turned on (S206). Then, raw data of the white reference data is acquired through the image sensor 72 (S208). At this moment, for example, data for four lines is acquired as the raw data of the white reference data. After the raw data of the white reference data for four lines is acquired as described above, the exposure lamp 66 is turned off (S210).

Then, it is determined whether the acquisition of the raw data of the white and black reference data is completed (S212). When it is determined that the acquisition of the raw data of the white and black reference data is not completed, the process proceeds back to step S204 and the raw data of the black and white reference data is acquired again (S204 to S210). The acquisition of the raw data of the black and white reference data is repeated until acquisition of all data is completed, that is, in this embodiment, each raw data of the white and black reference data is acquired four times.

When the acquisition of the raw data of the black and white reference data is completed, the scanner carriage 60 stops moving (S214). Then, the white and black reference data are acquired by a calculation process performed by the controller 120 and the like of the scanner control section 100 (S216). Then, the process ends promptly.

### Execution Timing

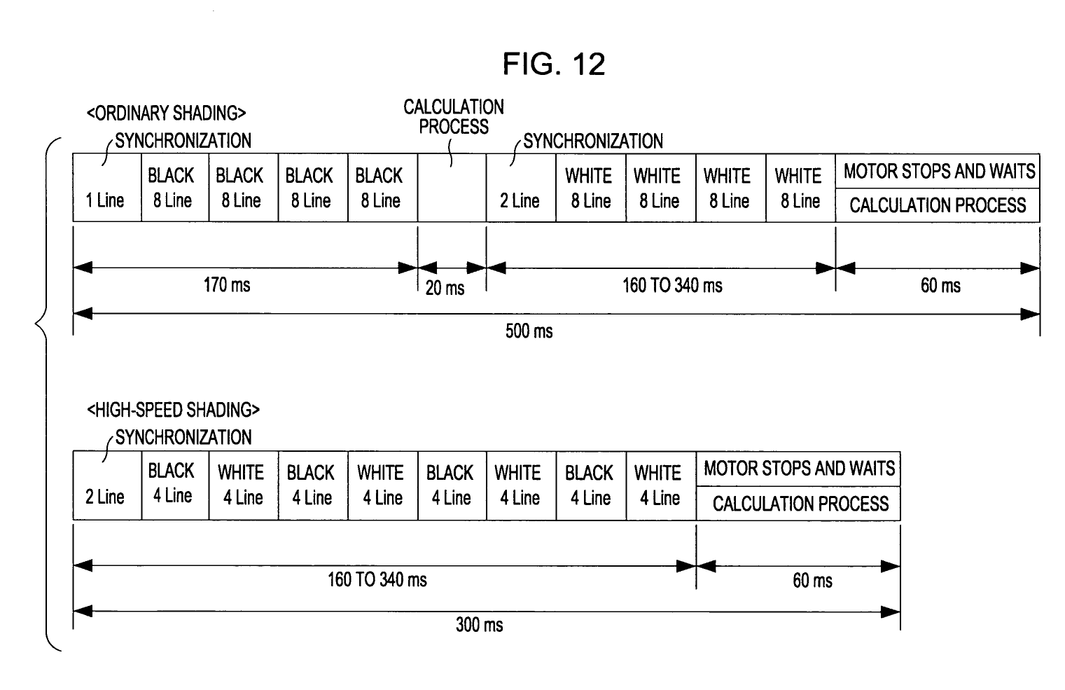

FIG. 12 is a diagram showing execution timings of the ordinary shading and the high-speed shading.

In the case of the ordinary shading, as shown in an upper portion of the figure, the black reference data is acquired through the image sensor 72 in a status in which the scanner carriage 60 is stopped. In other words, the raw data of the black reference data for eight lines is acquired total four times. For the acquisition of the raw data of the black reference data, here, a time of about 170 ms is required. Thereafter, a time of about 20 ms is required for a calculation process for acquiring the black reference data on the basis of the acquired raw data of the black reference data. After the scanner carriage 60 starts moving, the raw data of the white reference data for eight lines is acquired through the image sensor 72 total four times while the scanner carriage 60 moves. Here, a time of about 160 to 340 ms is required for the acquisition of the raw data of the white reference data. Thereafter, a time of about 60 ms is required for a process of stopping of the scanner carriage 60 in the predetermined image reading start position and a calculation process for acquisition of the white reference data on the basis of the acquired raw data of the white reference data.

As a result, an average time of 500 ms is required for the ordinary shading.

On the other hand, in the case of the high-speed shading, as shown in the lower portion of the figure, after the scanner carriage 60 starts moving, the exposure lamp 66 is repeatedly turned on and turned off at predetermined time intervals. When the exposure lamp 66 is turned on, raw data of the white reference data for four lines is acquired through the image sensor 72. In addition, when the exposure lamp 66 is turned off, raw data of the black reference data for four lines is acquired through the image sensor 72. The exposure lamp 66 is repeatedly turned on and turned off total four times. Accordingly, the raw data of the white reference data for four times X four lines and the raw data of the black reference data for four times X four lines are acquired. For the acquisition of the raw data of the white and black reference data, a time of 160 to 340 ms is required. Thereafter, a time of about 60 ms is required for a process of stopping of the scanner carriage 60 in the predetermined image reading start position and a calculation process for acquisition of the white reference data on the basis of the acquired raw data of the white reference data.

As a result, an average time of 300 ms is required in the high-speed shading. In other words, it is confirmed that the processing time can be reduced markedly in the high-speed shading, compared to a case of the ordinary shading.

### Execution Condition

Here, a timing for performing the high-speed shading will be described. Although the high-speed shading may be performed each time an image is read from a document in replace of the ordinary shading that has been generally performed, there are cases where a shading quality compatible to a general case is required, and accordingly, a case where the high-speed shading and the ordinary shading are used in a combination will be described.

Here, the high-speed shading is performed when a predetermined image reading condition is satisfied. For example, when a local copy for printing an image read from a document on a medium is performed, the high-speed shading is used if the quality of the medium on which the image read from the document is printed is low or the like. In particular, when the image read from the document is printed on plain paper or the like, the high-speed shading is performed. In addition, when a type of the document from which an image is read is a text or the like, the high-speed shading can be used.

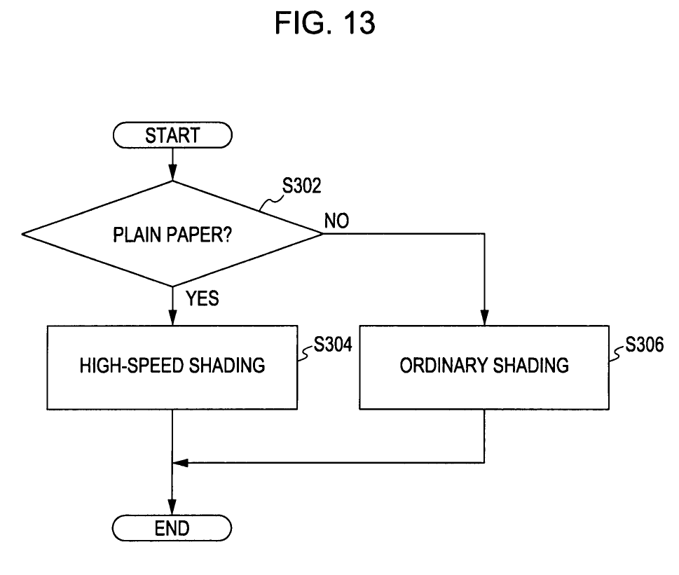

FIG. 13 is a flowchart showing a case where the high-speed shading is used at a time when a printing operation on plain paper is performed. When a local copy is performed, it is checked whether a medium on which an image read from a document is printed is plain paper (S302). When the printing medium is plain paper, the high-speed shading is performed at a time when the image is to be read from the document (S304). On the other hand, when the printing medium is a high-quality medium other than the plain paper, the ordinary shading is performed at a time when the image is to be read from the document (S306).

By switching between the high-speed shading and the ordinary shading described above, a more appropriate shading process can be performed. Accordingly, appropriate white and black reference data can be acquired.

### Other Related Processes

In this embodiment, processes such as a light source warm-up process and an AFE calibration process other than the high-speed shading and the ordinary shading are performed. The light source warm-up process and the AFE calibration process are performed before the high-speed shading or the ordinary shading is performed. The light source warm-up process and the AFE calibration process correspond to a setting process. Hereinafter, the light source warm-up process and the AFE calibration process will be described in detail.

### (1) Light Source Warm-Up Process

The light source warm-up process is a process for adjusting light intensity of a light source, that is, the exposure lamp 66 in this embodiment. In particular, an appropriate setting value is set in a light intensity control unit used for adjusting the light intensity of the exposure lamp 66, that is, a lamp control unit 124 in this embodiment. Accordingly, the exposure lamp 66 is controlled to have an appropriate light intensity.

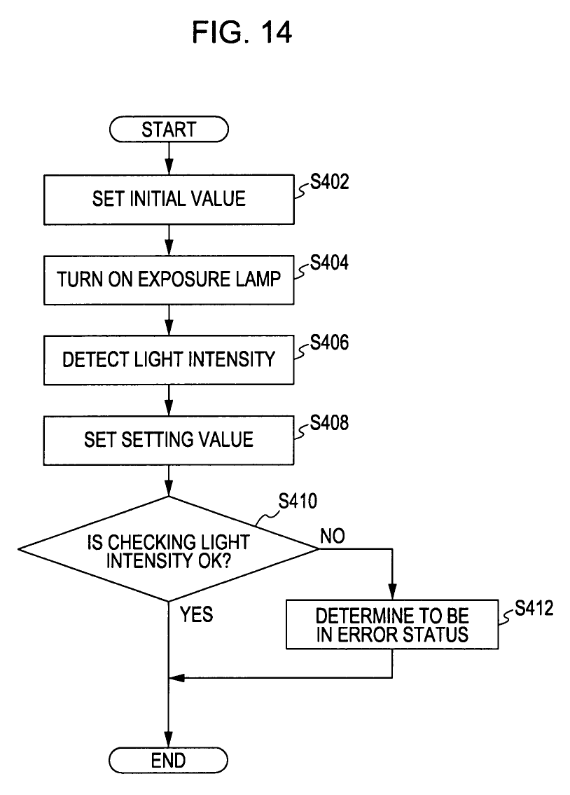

FIG. 14 is a flowchart showing a sequence of the light source warm-up process as an example. In the light source warm-up process, first, the lamp control unit 124 acquires an initial value stored in advance as a setting value for controlling the light intensity of the exposure lamp 66 (S402). Then, the lamp control unit 124 lights the exposure lamp 66 on the basis of the acquired initial value. Accordingly, the exposure lamp 66 is turned on to have a light intensity that is controlled by the lamp control unit 124 on the basis of the initial value stored in advance (S404).

Next, the light intensity of the exposure lamp 66 that is turned on on the basis of the initial value stored in advance as described above is detected (S406). Here, the light intensity of the exposure lamp 66 is detected by the image sensor 72 (image reading sensor). The image sensor 72 detects light from the turned on exposure lamp 66 and outputs a detection signal to the AFE (Analog Front End) part 128. The AFE (Analog Front End) part 128 performs a signal processing for the detection signal output from the image sensor 72 by using the analog signal processing circuit 132. Then, the AFE (Analog Front End) part 128 converts the analog detection signal for which the signal processing has been performed by the analog signal processing circuit 132 into a digital signal by using the A/D converter circuit 134. The detection signal converted into the digital signal is transmitted to the controller 120 and the like, and thereby the light intensity of the exposure lamp 66 is detected.

The exposure lamp 66, as described above with reference to FIGS. 8A and 8B, is constituted by the LED lamps 67B, 67C, and 67D in R, G, and B colors. Thus, the light intensity of the exposure lamp 66 is detected as the light intensities of the LED lamps 67B, 67C, and 67D in R, G, and B colors. In particular, the light intensity of the exposure lamp 66 is detected as the light intensities of the LED lamps 67B, 67C, and 67D in R, G, and B colors such as (R, G, B)=(180, 120, 160).

The controller 120 or the like sets an appropriate setting value in the lamp controller 124 on the basis of the acquired light intensity of the exposure lamp 66 such that the light intensity of the exposure lamp 66 is appropriate (S408). In particular, since the exposure lamp 66 is constituted by the LED lamps 67B, 67C, and 67D in R, G, and B colors, the setting value of the lamp controller 124 is acquired such that the light intensities of the LED lamps 67B, 67C, and 67D in R, G, and B colors are almost the same. For example, in a case where the light intensities are adjusted to a LED lamp having the highest light intensity, the setting value of the lamp controller 124 is acquired such that the light intensities of the LED lamps 67B, 67C, and 67D in R, G, and B colors (R, G, B)=(180, 180, 180). The operation for controlling the light intensities of the LED lamps 67B, 67C, and 67D in R, G, and B colors, as shown in FIG. 8B, is performed by controlling lighting time intervals Tr, Tg, and Tb of the LED lamps 67B, 67C, and 67D in R, G, and B colors.

As described above, after the setting value is set in the lamp controller 124 as the acquired setting value, the exposure lamp 66 is turned on on the basis of the set setting value, and the light intensity thereof is detected again so as to check whether the light intensity is appropriate (S410). The detection of the light intensity of the exposure lamp 66 is performed by the image sensor 72. Then, it is checked whether the light intensities of the LED lamps 67B, 67C, and 67D in R, G, and B colors are almost the same.

When the light intensities of the LED lamps 67B, 67C, and 67D in R, G, and B colors are almost the same, the process ends promptly. On the other hand, when the light intensities of the LED lamps 67B, 67C, and 67D in R, G, and B colors are not almost the same, the occurrence of an error is determined (S412). Then, the process ends promptly. As described above, the light source warm-up process is performed.

### (2) AFE Calibration Process

The AFE calibration process controls various settings of a signal amplifier circuit for amplification of a signal output from the image sensor 72, that is, various settings of the AFE (Analog Front End) part 128 in this embodiment. In particular, appropriate setting values are set in the analog signal processing circuit 132, the A/D converter circuit 134, or the like of the AFE (Analog Front End) part 128. Accordingly, it is controlled that the AFE (Analog Front End) part 128 appropriately amplifies the signal sent from the image sensor 72.

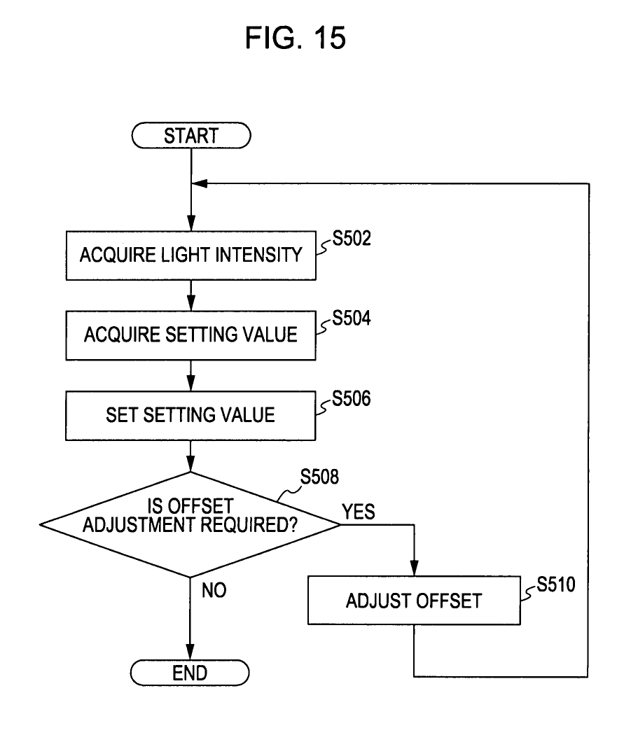

FIG. 15 is a flowchart showing a sequence of the AFE calibration process as an example. This AFE calibration process is performed after the light source warm-up process described above with reference to FIG. 14 is performed. In the AFE calibration process, first, the light intensity of the exposure lamp 66 which has been adjusted in the light source warm-up process is acquired (S502). Here, for example, the light intensity detected for checking in step S410 of the light source warm-up process described above with reference to FIG. 14 or the like may be used.

Then, the controller 120 and the like acquire the setting value of the AFE (Analog Front End) part 128 on the basis of the acquired light intensity of the exposure lamp 66 (S504). In particular, the controller 120 and the like acquire a gain value of the AFE (Analog Front End) part 128 which increases an output level of the AFE (Analog Front End) part 128 as the setting value when the light intensity of the exposure lamp 66, which has been controlled by the light source warm-up process, is low. Then, the controller 120 and the like set the acquired setting value in the AFE (Analog Front End) part 128 (S506).

As described above, the controller 120 and the like set the setting value in the AFE (Analog Front End) part 128 and then determine whether an offset is required to be adjusted (S508). Here, an offset adjustment process is performed, so that a low value as the output level of the AFE (Analog Front End) part 128 is not output. For example, the output value of the AFE (Analog Front End) part 128 is adjusted so as not to be a negative value. The controller 120 and the like determine whether this adjustment process is required.

When the controller 120 and the like determine that the offset adjustment process is required, the process proceeds to step S510 for performing an adjustment process of the offset (S510). Then, the process proceeds back to the acquisition of the light intensity of the exposure lamp 66 (S502), and the process for the acquisition of the setting value of the AFE (Analog Front End) part 128 and thereafter are performed again (S504 to S508). On the other hand, when the controller 120 and the like determine that the offset adjustment process is not required, the process ends promptly. As described above, the AFE calibration process is performed.

### Execution Timing

Although the timings at which the light source warm-up process and the AFE calibration process are executed are set before an image is read from a document by the image sensor 72, the light source warm-up process and the AFE calibration process are not performed each time the image is read from the document. In other words, the light source warm-up process and the AFE calibration process are performed only when they are needed.

In this embodiment, the following timings as the execution timing of the light source warm-up process and the AFE calibration process will now be described.

### (1) Light Intensity Check

When an image is read from a document, the light intensity of a light source, that is, the exposure lamp 66 is detected by the image sensor 72, and it is determined whether the light source warm-up process and the AFE calibration process are required on the basis of the detection result. Only when it is determined that the light source warm-up process and the AFE calibration process are required to be performed, the light source warm-up process and the AFE calibration process are performed.

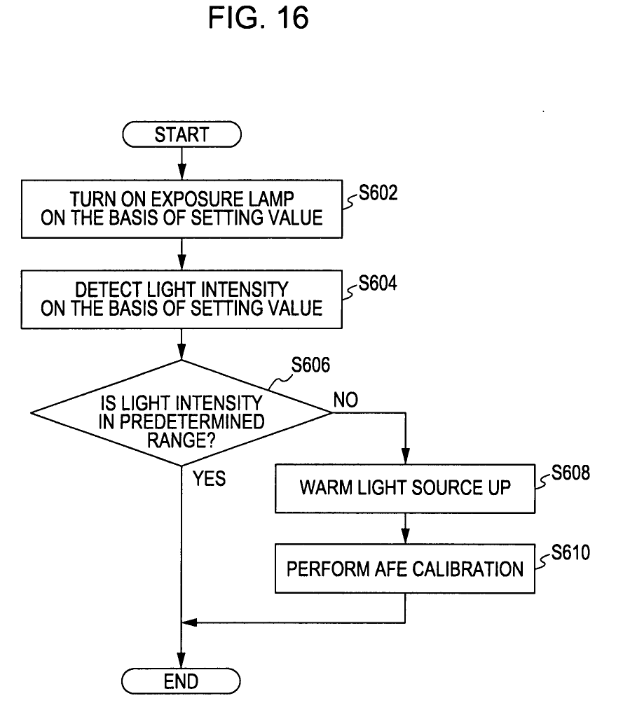

FIG. 16 is a flowchart showing a process sequence in such a case, as an example. Here, first, the lamp controller 124 lights the exposure lamp 66 on the basis of the setting value that has been set by the previous light source warm-up process (S602). Then, the light intensity of the turned on exposure lamp 66 is detected by the image sensor 72 (S604).

A signal output from the image sensor 72 that has detected the light intensity of the exposure lamp 66 is input to the AFE (Analog Front End) part 128. The AFE (Analog Front End) part 128 performs a signal processing for the signal output from the image sensor 72 using the analog signal processing circuit 132 on the basis of the setting value set by the previous AFE calibration process and converts the resultant analog signal into a digital signal using the A/D converter circuit 134. Then, the detection signal converted into the digital signal is transmitted to the controller 120 and the like, and thereby the light intensity of the exposure lamp 66 is detected. Here, the light intensity of the exposure lamp 66 is detected as the light intensities of the LED lamps 67B, 67C, and 67D in R, G, and B colors.

When acquiring the light intensity of the exposure lamp 66 through the AFE (Analog Front End) part 128, the controller 120 and the like check whether the light intensity is in a predetermined range (S606). When the light intensity of the exposure lamp 66 is in the predetermined range, it is determined that the light source warm-up process and the AFE calibration process are not required to be performed, and thereby the process ends instantly.

On the other hand, when the light intensity of the exposure lamp 66 is not in the predetermined range, it is determined that the light source warm-up process and the AFE calibration process are required to be performed, and thereby the light source warm-up process and the AFE calibration process are performed. In such a case, first, the light source warm-up process is performed (S608), and then the AFE calibration process is performed (S610). After the light source warm-up process and the AFE calibration process are performed as described above, the process ends promptly.

### APPLICATION EXAMPLE

Hereinafter, a case where the method is applied in practical use will be described. Here, a case where an operation for local copy is performed in the multifunctional apparatus 1 according to the embodiment will be described.

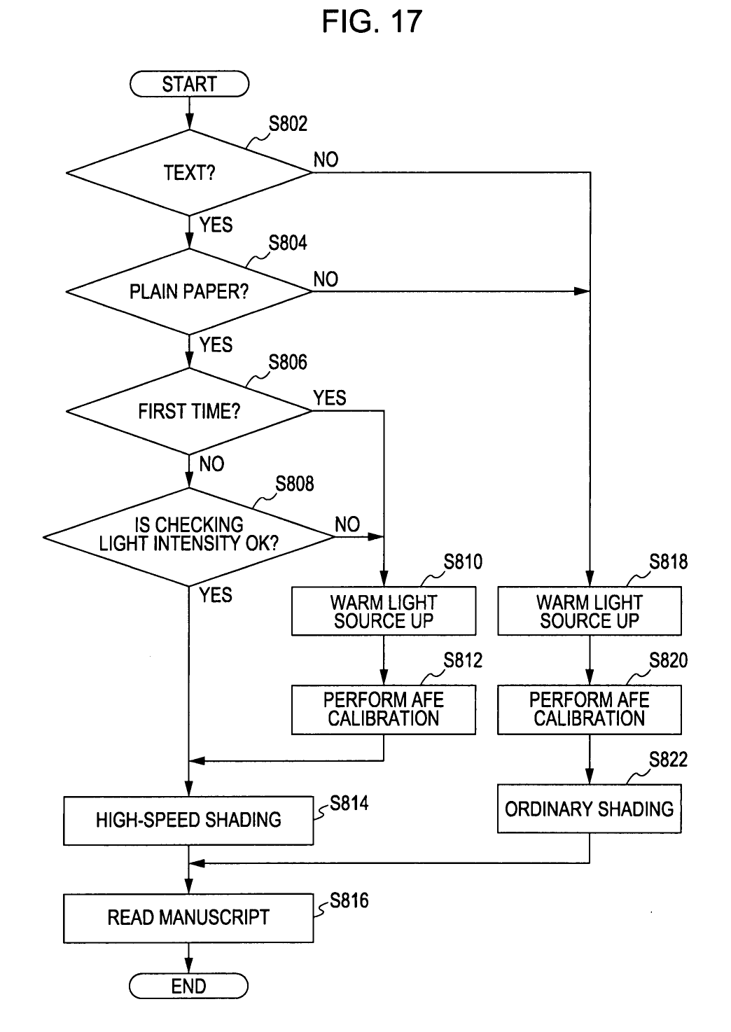

FIG. 17 is a flowchart showing a case where the method is applied in practical use. Only when the document from which an image is read is a text document and the type of a printing medium is plain paper, the light source warm-up process and the AFE calibration process are omitted and the high-speed shading is performed.

First, it is checked whether the document from which the image is read is a text document (S802). When the document from which the image is read is not the text document, the process proceeds to step S818, and the light source warm-up is performed (S818), and the AFE calibration process is performed (S820). Thereafter, the ordinary shading is performed (S822). Then, after a reading operation for reading an image from the document is performed (S816), the process ends.

On the other hand, when the document from which the image is read is the text document, the process proceeds to step S804, and it is checked whether the printing medium is plain paper (S804). When the printing medium is not the plain paper, the process proceeds to step S818, and the light source warm-up process is performed (S818). Thereafter, the AFE calibration process is performed (S820). Thereafter, the ordinary shading process is performed (S822). Then, after the reading operation for reading an image from the document is performed (S816), the process ends.

When the printing medium is plain paper, the process proceeds to step S806 and it is checked whether the operation for reading an image from the document is to be performed for the first time (S806). When the operation for reading an image from the document is to be performed for the first time, the process proceeds to step S810, and the light source warm-up process is performed (S810). Thereafter, the AFE calibration process is performed (S812). Then, the high-speed shading is performed (S814). Then, after the reading operation for reading the image from the document is performed (S816), the process ends.

On the other hand, when the operation for reading an image from the document is to be performed not for the first time, that is, a second time or thereafter, the process proceeds to step S808, and the light intensity of the light source (exposure lamp 66) is checked (S808). When the light intensity of the light source (exposure lamp 66) is not in the predetermined range, the process proceeds to step S810, and the light source warm-up process is performed (s810). Then, the AFE calibration is performed (S812). Thereafter, the high-speed shading is performed (S814). Then, after the reading operation for reading the image from the document is performed (S816), the process ends.

On the other hand, when the light intensity of the light source (exposure lamp 66) is in the predetermined range, the process proceeds to step S814, and the high-speed shading is performed (S814). Then, after the reading operation for reading the image from the document is performed (S816), the process ends promptly.

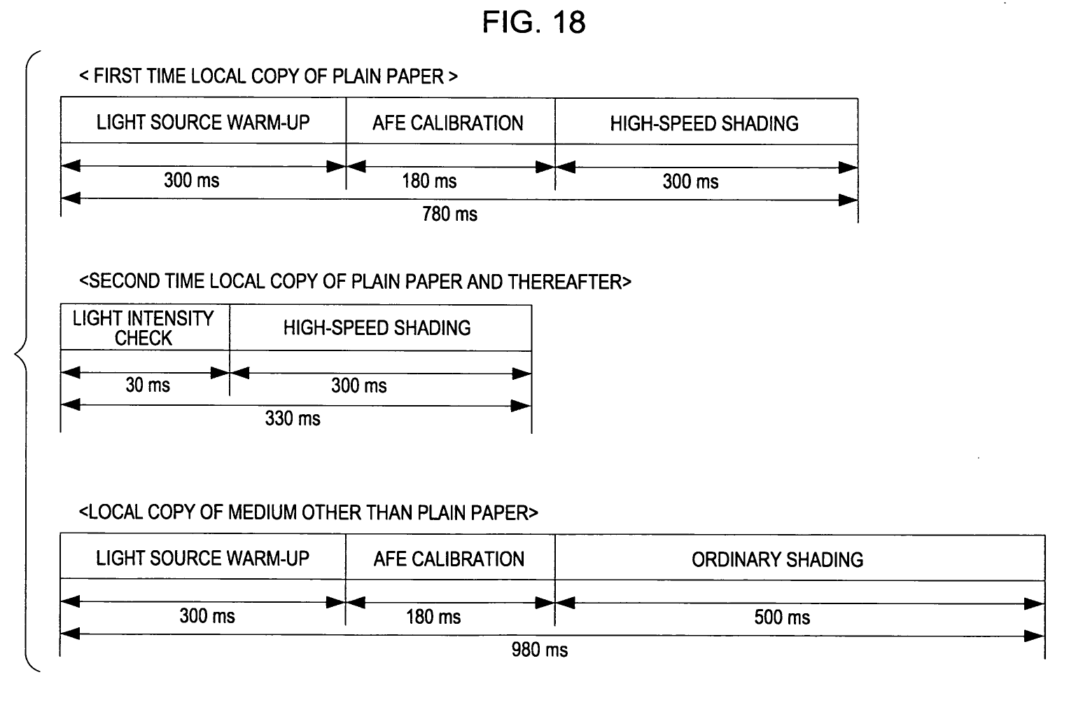

FIG. 18 is a diagram showing a comparison result of execution time for the processes. When a document from which an image is read is a text document, the type of printing medium is plain paper, and an operation for local copy is performed for the first time, the light source warm-up process and the AFE calibration process are performed. Thereafter, the high-speed shading is performed. Thus, when a time required for the light source warm-up process is 300 ms, a time required for the AFE calibration process is 180 ms, and a time required for the high-speed shading is 300 ms, the total time required for the processes is 780 ms.

On the other hand, when a document from which an image is read is a text document, the type of printing medium is plain paper, and the operation for local copy is performed for a second time or thereafter, the light intensity checking process and the high-speed shading are performed. Thus, when a time required for the light intensity checking process is 30 ms, then the total time required for the processes is 330 ms.

On the other hand, when a document from which an image is read is a document other than a text, for example, a photo document and the type of printing medium is paper other than the plain paper, for example, photo paper or special paper, the light source warm-up process and the AFE calibration process are performed. Thus, when a time required for the ordinary shading is 500 ms, the total time required for the processes is 980 ms.

Accordingly, when the document from which an image is read is a text document and the type of a printing medium is plain paper, the high speed shading is performed and the light source warm-up process and the AFE calibration process are omitted in the operation for local copy performed for the second time or thereafter, and thereby a time required for a process of reading an image from a document can be reduced markedly.

### Summary

In the above-described embodiment, in the high-speed shading, while the scanner carriage 60 moves relative to the white reference plate 140, facing the white reference plate, and the exposure lamp 66 is repeatedly turned on and turned off at predetermined time intervals. When the exposure lamp 66 is turned on, the white reference data is acquired on the basis of the detection signal output from the image sensor 72. In addition, when the exposure lamp 66 is turned off, the black reference data is acquired on the basis of the detection signal output from the image sensor 72. Therefore, it is possible to reduce a time required for acquisition of the white and black reference data.

By performing the ordinary shading generally performed along with the above-described high-speed shading, it is possible to appropriately switching between the high-speed shading process and the ordinary shading process. Accordingly, a more appropriate shading process can be performed, and appropriate white and black reference data can be acquired.

### OTHER EMBODIMENTS

While the present invention has been particularly described with reference to exemplary embodiments thereof, the exemplary embodiments should be considered in descriptive sense only and not for purposes of limitation. In addition, various changes or modifications may be made therein without departing from the gist of the invention, and all differences within the scope will be construed as being included in the present invention. Particularly, the exemplary embodiments described below are also included in the present invention.

### Image Reading Sensor

In the above-described embodiment, although the image sensor 72, described above with reference to FIG. 7, has been described as the image reading sensor, however, the image reading sensor is not limited to the image sensor 72. In other words, any type of image reading sensor may be used, as long as the image reading sensor can read an image from a document.

### Light Source

In the above-described embodiment, although the LED lamps 67B, 67C, and 67D in R, G, and B colors are provided as the light source, however, the light source according to an embodiment of the invention is not limited thereto. In other words, any type of light source may be used as long as the light source can be turned on or turned off at a time when an image is read from a document by an image reading sensor. In particular, a lamp such as a xenon lamp or a mercury lamp which is generally used in an image reading apparatus (scanner) may be used.

### Image Reading Apparatus

In the above-described embodiment, although a multifunctional apparatus having a scanner unit for reading an image from a document and generating image data and a printer unit for printing on a medium has been described as an image reading apparatus as an example, however, the image reading apparatus according to an embodiment of the invention is not limited to this type of image reading apparatus. In other words, any type of image reading apparatus may be used, as long as the image reading apparatus can read an image from a document.

What is claimed is:

1. An image reading apparatus comprising:
an image reading sensor reading an image from a document;
a light source turned on at a time when the image is read from the document by the image reading sensor;
a data acquisition unit acquiring white reference data and black reference data which are used for performing shading correction for the image read by the image reading sensor; and
a white reference plate for acquiring the white reference data,
wherein the image reading sensor moves relative to the white reference plate while facing the white reference plate when the white reference data and the black reference data are acquired by the data acquisition unit,
wherein the light source is repeatedly turned on and turned off when the image reading sensor moves relative to the white reference plate, and
wherein the data acquisition unit acquires the white reference data on the basis of a detection signal that can be acquired from the image reading sensor at a time when the light source is turned on and acquires the black reference data on the basis of a detection signal that can be acquired from the image reading sensor at a time when the light source is turned off.

2. The image reading apparatus according to claim 1, wherein the light source is repeatedly turned on and turned off at predetermined time intervals.

3. The image reading apparatus according to claim 1, wherein the image reading sensor moves relative to the white reference plate at a predetermined moving speed.

4. The image reading apparatus according to claim 1, wherein the white reference data and the black reference data are acquired by the data acquisition unit before the image is read from the document by the image reading sensor.

5. The image reading apparatus according to claim 1, wherein an operation in which the image reading sensor moves relative to the white reference plate while facing the white reference plate and the light source is repeatedly turned on and turned off is performed when an image reading condition corresponds to a predetermined condition.

6. The image reading apparatus according to claim 5, wherein other operation other than the operation is performed when the image reading condition does not correspond to the predetermined condition.

7. The image reading apparatus according to claim 6,
wherein, as the other operation, the light source is turned off and the data acquisition unit acquires the black reference data on the basis of the detection signal that can be acquired from the image reading sensor by the data acquisition unit before the image reading sensor moves relative to the white reference plate, and
wherein, as the other operation, the light source is turned on and the data acquisition unit acquires the white reference data on the basis of the detection signal that can be acquired from the image reading sensor by the data acquisition unit when the image reading sensor moves relative to the white reference plate, facing the white reference plate.

8. The image reading apparatus according to claim 1, wherein the data acquisition unit acquires the white reference data or the black reference data on the basis of the detection signal for a plurality of lines which can be acquired from the image reading sensor.

9. The image reading apparatus according to claim 1, wherein a setting process for setting values in a signal amplifier circuit amplifying a signal output from the image reading sensor and a light intensity control unit controlling light intensity of the light source is performed before the white reference data and the black reference data are acquired by the data acquisition unit.

10. The image reading apparatus according to claim 9, wherein the setting process is performed on the basis of the signal that is output from the image reading sensor having detected the light intensity of the light source and is amplified by the signal amplifier circuit.

11. The image reading apparatus according to claim 10,
wherein, when the image reading condition corresponds to the predetermined condition, the light intensity of the light source that is controlled to be turned on by the light intensity control unit in which the setting values are set by the setting process is detected by the image reading sensor and it is determined whether the light intensity of the light source is in a predetermined range on the basis of the signal that is output from the image reading sensor having detected the light intensity of the light source and is amplified by the signal amplifier circuit in which the values are set,
wherein when it is determined that the light intensity of the light source is not in the predetermined range, the setting process is performed, and
wherein when it is determined that the light intensity of the light source is in the predetermined range, the setting process is not performed.

12. An image reading method comprising:
moving an image reading sensor relative to a white reference plate while the image reading sensor faces the white reference plate when white reference data and black reference data which are used for performing shading correction for an image read by the image reading sensor are to be acquired before the image is read from a document by the image reading sensor;
repeating operations for alternately turning on and turning off a light source to be turned on at a time when the image reading sensor moves relative to the white reference plate; and
acquiring the white reference data on the basis of a detection signal that can be acquired from the image reading sensor at a time when the light source is turned on and acquiring the black reference data on the basis of a detection signal that can be acquired from the image reading sensor at a time when the light source is turned off.

13. A program executable in an image reading apparatus, the program executing a method comprising:
moving an image reading sensor relative to a white reference plate while the image reading sensor faces the white reference plate when white reference data and black reference data which are used for performing shading correction for an image read by the image reading sensor are to be acquired before the image is read from a document by the image reading sensor;
repeating operations for alternately turning on and turning off a light source to be turned on at a time when the image reading sensor moves relative to the white reference plate;
acquiring the white reference data on the basis of a detection signal that can be acquired from the image reading sensor at a time when the light source is turned on; and
acquiring the black reference data on the basis of a detection signal that can be acquired from the image reading sensor at a time when the light source is turned off.
